(19) United States
(12) Patent Application Publication
(10) Pub. No.: US 2008/0184636 A1
(43) Pub. Date: Aug. 7, 2008

(54) LED illuminated glazing materials

(76) Inventor: Mike Alan Fisher, Bend, OR (US)

Correspondence Address: HANCOCK HUGHEY LLP, P.O. BOX 1208, SISTERS, OR, 97759, US

(21) Appl. No.: 11/701,824

(22) Filed: Feb. 2, 2007

(51) Int. Cl. E06B 3/24

(52) U.S. Cl. 52/204.5

(57) ABSTRACT

A glazing system such as a window that includes a glazing member and an LED that emits light into an edge portion of the glazing member and transmits light from one or both major surfaces of the glazing members.

### BACKGROUND OF THE INVENTION

This invention relates to glazing materials such as glass or polymeric materials that are used in windows, doors and picture frames.

Glazing materials are used extensively in both residential and commercial buildings in windows, mirrors and artwork. As a result the selection and placement of glazing materials have a significant impact on the appearance of the exterior and interior of the building. While in certain applications glazing materials can be coated with tintin material or can even include colorants in the glazing material, once selected and installed a particular glazing material is fixed in appearance.

This invention relates to a glazing system which can alter the appearance of the glazing system by illuminating the glazing in a manner that imparts unique properties to the glazing material system

The invention is embodied in a glazing material that can be selectively illuminated from an edge of the material by a light emitting diode (LED). In one preferred embodiment of the invention, the glazing is mounted in a peripheral frame. One or more LED's are mounted in the frame adjacent one or more edges of the glazing material. When the LED is activated it emits light through the edge of the glazing into the glazing material. As a result of the internal refractive and reflective properties of the glazing material, a portion of the LED light is emitted from substantially all of the major surfaces of the glazing material, selectively illuminating the major surfaces of the glazing.

In various preferred embodiments LED's can be mounted adjacent a single edge of the glazing or adjacent multiple edges of the glazing. LED's of a single color or LED's of different colors can be used, and can be selectively activated to selectively impart different colors to the glazing. The different colors can be selectively activated to alter the visual appearance of the glazing for decorative purposes. The LED's or differently colored LED's can be activated responsive to sensors to indicate various conditions or occurrences within the space adjacent the glazing. For instance, the LED's can be connected to sensors that activate the LED's to provide a visual alert when the window is ajar, when motion is detected within the adjacent space, when a predetermined high or low temperature is detected within the space, or to provide a visual indication of nearly any other condition that can be detected and which can trigger an electrical or mechanical sensing mechanism to generate a triggering or control signal.

In other embodiments of the invention the glazing assembly can include multiple spaced apart glazing members such as those known as double or triple glazed windows. In such embodiments the LED can be mounted to emit into the space between the spaced apart glazing members, and the light from the LED can be transmitted from major surfaces of either or both glazing members by selectively coating one or more surfaces of either glazing member. Alternatively, differently colored LED's can be placed adjacent the respective spaced apart glazing members to selectively emit a different color of light into each glazing member.

These and other aspects of the invention will be discussed in greater detail by reference to the drawings.

### BRIEF DESCRIPTION OF THE DRAWINGS

FIG. 1 is a schematic side elevational view of a preferred embodiment of the invention.

FIG. 2 is a side elevational view of the embodiment shown in FIG. 1.

FIG. 3 is a side view of an alternate embodiment in which a plurality of LED's are employed.

FIG. 4 is a side view of an alternate embodiment of the invention utilizing two spaced apart glazing members.

FIG. 5 is a front view of another embodiment of the invention in which a glazing member is placed over a decorative surface and light from the LED is used to illuminate or to alter the appearance of the underlying decorative surface.

FIG. 6 is a side view of the embodiment shown in FIG. 5.

FIG. 7 is a partial cross-sectional view of yet another embodiment of a dual glazed window assembly according to the invention.

### DETAILED DESCRIPTION OF THE INVENTION

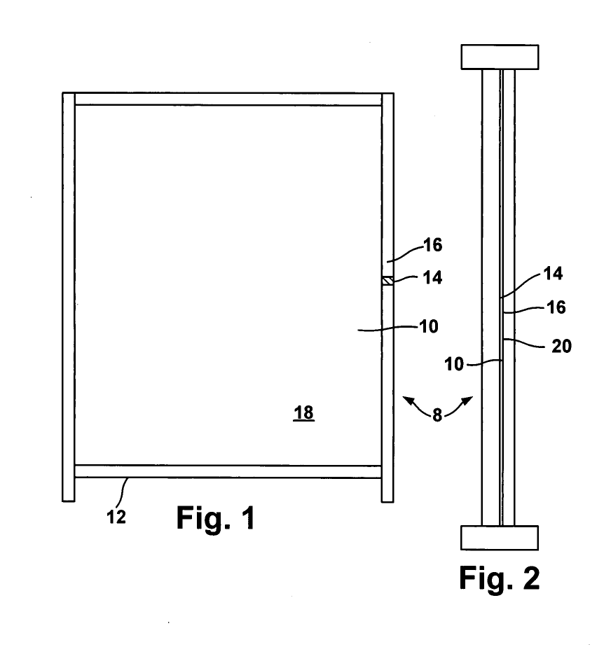

Referring to FIG. 1, in a preferred embodiment an apparatus 8 according to the invention includes a glazing member 10, a frame 12 surrounding the glazing member 10, and a light emitting diode (LED) 14. The glazing material 10 can be made of any of a number of materials including glass and polymeric glazing materials such as polycarbonate, and the invention is not limited to any particular glazing material.

LED 14 is positioned adjacent edge 16 so as to emit light into the glazing member 10 through edge 16. When LED 14 is activated and emits light into glazing material 10, the material of glazing member 10 embodies inherent refractive and internally reflective properties that result in some or all of the light being emitted through major surfaces 18 and 20 of glazing member 10. In various embodiments edge 16 can be shaped to maximize the amount of light transmitted into glazing member 10 according to well-known optical principals. Glazing members 10 can be optionally coated with a coating 24 that enhances or limits the emission of light from surface 18 or 20. In other embodiments the LED can be positioned to emit light into glazing member 10 through a major surface 18 or 20.

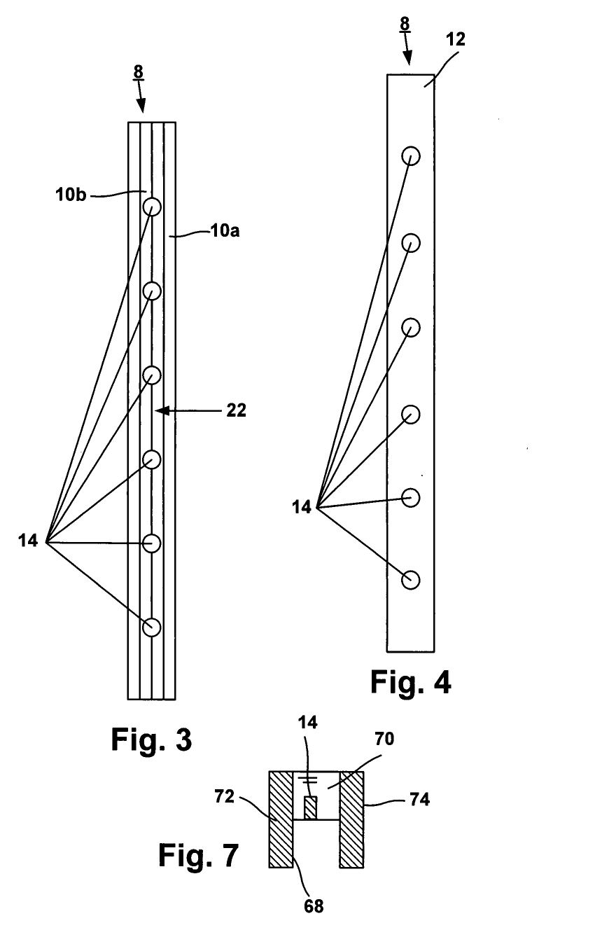

LED 14 can be selected to emit any particular color of light, and the invention is not limited to any particular type or color of LED. LED 14 can be mounted in a frame surrounding glazing material 10 and which is either fixed or movable relative to the glazing material or relative to the surrounding structure. Referring to FIG. 3, in another embodiment of the invention a plurality of LED's 14 can be mounted in the assembly. The multiple LED's can be of a uniform color or of differing colors.

Referring to FIG. 4, the invention is also embodied in a multiple glazing window system which includes two or more spaced apart glazing members 10a and 10b and a space 22 there between. In such embodiments, LED's 14 can be mounted adjacent an edge 16 of one or both glazing members 10a and/or 10b, or between in space 22 as shown in FIG. 4.

Referring to FIG. 7, certain designs of single and double glazed windows adhere a spacer 70 between glazing sheets 72 or 72 and 74 in the case of double glazed window units. The glazing and spacer assembly is then mounted in a frame or opening in the structural framework. In this embodiment LED 14 and electrical connector 76 is mounted in spacer 70. In certain embodiments wherein spacer is an extruded polymeric material, one or multiple LED's and their respective electrical connectors are embedded in spacer 70 during the extrusion process.

Whether single or multiple LED's are used, each LED 14 is connected to an electrical source (not shown) that applies a voltage to the LED according to well-understood principles and engineering practices. Each LED can be separately connected to an individual supply circuit, or multiple LED's can be connected together in a single circuit. In embodiments wherein the window can be raised or lowered in the frame, the electrical circuits and connections can be configured to illuminate LED(s) 14 depending on whether the window is opened or closed, or irrespective of the position of the glazing member 10 relative to the surrounding frame.

Any number of control mechanisms can be employed to activate LED (s) 14. They can be activated responsive to night falling to illuminate the windows of a building for a pleasing architectural effect. The LED(s) can be activated by a remote manually operated switch. In another embodiment, LED(s) 14 can be activated when the window is either open or shut to indicate the position of the window relative to the frame. The LED(s) can be activated by temperature sensors to trigger a visual alarm if the room exceeds a predetermined temperature range, e.g. as a fire alarm. The LED's can be activated by a security alarm system to provide a visual indication of an intruder or other security breach in an adjacent space. Any other desired condition or event that can be sensed and used to transmit a control signal to activate one or more of LED(s) 14 is within the scope of the invention.

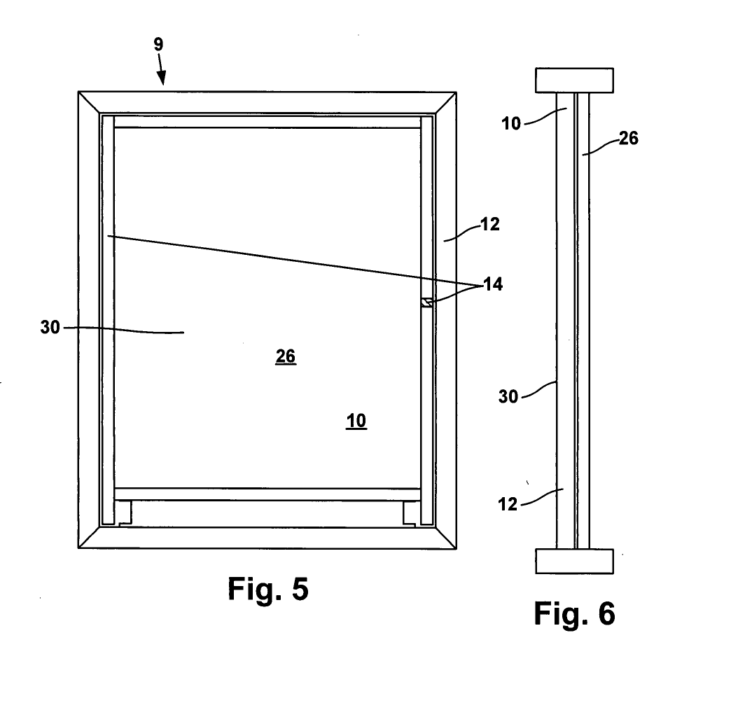

In another embodiment 9 as shown in FIGS. 5 and 6, glazing member 10 is positioned over a decorative surface or graphical work, i.e. a piece of artwork 26 rather than comprising a glazing member in a window. In these embodiments, single or multiple LED(s) 14 can be employed, and which are otherwise as described and controlled in the above-referenced embodiments. LED(s) 14 can be used to illuminate artwork 26. In other embodiments, the color of LED(s) 14 can be selected to complement or alter the appearance of the underlying artwork 26 as desired or required, and in particular could be used to effectively alter the color balance of ambient light. This can be particularly useful for example where a piece of artwork was intended to be displayed, or presents a better appearance in natural light, but is displayed in artificial light.

In another aspect of the invention it can also be employed to protect underlying artwork from harmful or degrading light or radiation. In this embodiment coating 30 selected to reflect a pre-selected radiation, e.g. UV radiation, is applied to the outer major surface of glazing member 10. At the same time, coating 30 permits LED generated light transmitted into glazing member 10 and reflected from the underlying artwork to be transmitted through glazing member 10 to a viewer.

While the invention has been described in by way of the foregoing preferred embodiments, they are intended to illustrate the invention rather than to limit the invention. Those of skill in the art will recognize that the described embodiments could be varied in detail and arrangement without departing from the scope of the claims.

I claim:

1. A window assembly comprising:
a window frame;
at least one glazing member mounted in the frame;
at least one light emitting diode (LED) positioned to emit light onto the at least one glazing member.

2. A window assembly according to claim 1 wherein the at least one LED comprises a plurality of LED's.

3. A window assembly according to claim 1 wherein the plurality of LED's comprises differently colored LED's.

4. A window assembly according to claim 1 wherein the at least one LED includes at least one preselected group of LED's that can be activated in a predetermined order.

5. A window assembly according to claim 1 wherein the at least one LED includes at least one preselected group of LED's that can be activated in a predetermined pattern.

6. A window assembly according to claim 1 wherein the at least one LED is connected to an electrical supply.

7. A window assembly according to claim 1 wherein the window assembly further comprises:
a mounting frame;
the window frame mounted in the mounting frame; and,
a first electrical connector mounted on the mounting frame and connected to an electrical supply;
a second electrical connector mounted on the window frame and connected to the at least one LED; and,
the first and second connectors operable to connect the at least one LED to the electrical supply.

8. A window assembly according to claim 1 wherein the at least one LED includes a controller.

9. A window assembly according to claim 8 wherein the window assembly further comprises a remote control on communication with the at least one LED.

10. A window assembly according to claim 1 wherein at least one glazing member includes a light dispersing surface.

11. A window assembly according to claim 1 wherein the at least one glazing member includes a pair of spaced apart glazing members defining an intermediate space.

12. A window assembly according to claim 11 wherein the LED emits light into the intermediate space.

13. A window assembly according to claim 1 wherein the LED is mounted to the at least one glazing member.

14. A window assembly according to claim 13 further comprising the at least one glazing member mounted in a frame, and a first electrical connector mounted on the frame and in communication with the LED.

15. A window assembly according to claim 10 wherein at least one glazing light dispersing surface comprises a discrete layer applied to the glazing.

16. A frame assembly for mounting a decorative object comprising:
a decorative object;
a glazing member covering at least a portion of the decorative object; and
at least one light emitting diode (LED) adjacent the glazing member and operable to emit light into the glazing member.

17. A frame assembly according to claim 1 further comprising:
a frame adjacent the glazing member; and
the at least one LED mounted in the frame.

18. A frame assembly according to claim 16 further comprising a coating on a major surface of the glazing, the coating selected from the group consisting of a reflective coating, a refractive coating, a light dispersive coating, a light filtering coating, and a translucent coating.

19. A frame assembly according to claim 16 wherein the LED is selected to alter the appearance of the decorative object.

20. A frame assembly according to claim 16 wherein the LED is selected to alter the appearance of the decorative object.

21. A frame assembly according to claim 16 wherein the LED is selected to shield the decorative object from a pre-selected ambient radiation.
